(19) United States
(12) Patent Application Publication
(10) Pub. No.: US 2012/0086228 A1
(43) Pub. Date: Apr. 12, 2012

(54) Tool for cleaning-up toys

(76) Inventor: Sherry Montella, Palatine, IL (US)

(21) Appl. No.: 12/924,850

(22) Filed: Oct. 6, 2010

(51) Int. Cl. A01B 1/02; A47L 13/52

(52) U.S. Cl. 294/181

(57) ABSTRACT

A tool for collecting toys from a play area including an elongate shaft having a distal end and a proximal end, a head coupled to the distal end of the shaft, and a chamfered strip. The head has a rear wall and a continuous side wall forwardly extending from the rear wall. The rear wall and the side wall define a toy collection cavity. The side wall has a lower region and first and second side regions. The lower region has a forward edge extending between the first and second side regions. The head is formed of a first material that is lightweight and rigid. The strip is attached to the forward edge of the lower region and is formed of a second material that is resilient and elastomeric. The strip is configured for contacting the toys within the play area without scratching the floor of the play area.

### FIELD OF THE INVENTION

The present invention relates to a tool for gathering, scooping and cleaning-up toys.

### BACKGROUND OF THE INVENTION

During play, small children and toddlers often play with numerous toys. These toys typically include multiple pieces, which overtime can become scattered about a play area, often in hard to retrieve locations such as underneath tables and chairs. A parent, guardian or sitter often finds themselves repeatedly collecting such toys from the ground. Such toy collection typically requires repeated bending, stooping and retrieval actions. Many parents, guardians and sitters find such repeated bending and stooping toy collection activities to be laborious, time consuming and even painful.

What is needed is a tool that can facilitate the collection and cleaning-up of various sized toys within a play area and eliminate the need to repeatedly stoop to retrieve toys strewn about a play area. Existing tools, such as brooms, traditional lawn rakes and shag rug rakes have drawbacks that render such tools impractical for collecting toys from a play area. Conventional brooms with multiple long flexible bristles are configured for collecting dirt, crumbs and other small particles. Such brooms are not configured for collecting and cleaning up toys of various shapes, sizes and weights. The long flexible bristles of brooms simply cannot easily reposition toy articles particularly on carpeted surfaces. Traditional lawn rakes are configured for collecting leaves and yard debris and are equipped with multiple prongs that can damage carpets and flooring. Further, the prongs of such lawn rakes are typically sharp and are made of metal or other hard material that can be hazardous to small children. Still further, lawn rakes are often quite heavy and difficult to maneuver in small play areas. Shag rug rakes are configured for straightening the pile of rugs and carpets and not for collecting and retrieving toys of various sizes. Traditional shag rug rakes are typically configured for adult use only and often have multiple prongs that can be harmful to small children in the play area. Further, brooms, lawn rakes and shag carpet rakes are not configured for scooping various sized toys.

It would thus be desirable to provide a tool for conveniently collecting toys of various shapes and sizes within a play area. It would also be desirable to provide a tool for collecting toys that can also be used to scoop the toys from the ground of a play area. What is needed is a tool for collecting toys that is lightweight, and easy and safe to use for adults and children. What is needed is a tool for collecting toys that does not harm play area flooring, such as carpets, rugs, hardwood floors, linoleum, and tiled floors.

### SUMMARY OF THE INVENTION

The present invention provides a tool for collecting toys from a play area. The tool includes an elongate shaft having a distal end and a proximal end, a head and a chamfered strip. The head is coupled to the distal end of the shaft. The head has a rear wall and a continuous side wall forwardly extending from the rear wall. The rear wall and the side wall define a toy collection cavity. The side wall has a lower region and first and second side regions. The lower region has a forward edge extending between the first and second side regions. The head is formed of a first material that is lightweight and rigid. The chamfered strip is attached to the forward edge of the lower region and is formed of a second material that is resilient and elastomeric. The strip is configured for contacting the toys within the play area without scratching the floor or the walls of the play area.

According to a principal aspect of the present invention, a tool for collecting toys from a play area. The tool includes an elongate shaft having a distal end and a proximal end, and a head coupled to the distal end of the shaft. The head has a curved rear wall and a continuous side wall forwardly extending from the rear wall. The rear wall and the side wall define a toy collection cavity. The side wall has a lower region and first and second side regions. The lower region has an outer surface and a forward edge extending between the first and second side regions. The head is configured such that when the shaft is positioned in a substantially vertical position, at least a portion of the lower region of the side wall extends substantially parallel with the ground of the play area and at least a portion of the outer surface of the lower region contacts the ground of the play area. The head is configured for contacting, collecting and scooping of the toys within the play area.

This invention will become more fully understood from the following detailed description, taken in conjunction with the accompanying drawings described herein below, and wherein like reference numerals refer to like parts.

### BRIEF DESCRIPTION OF THE DRAWINGS

FIG. 1 is a front view of a toy-collecting tool.

FIG. 2 is a rear view of the toy collecting tool of FIG. 1.

FIG. 3 is a side view of the toy collecting tool of FIG. 1.

FIG. 4 is a front view of a toy collecting tool in accordance with an alternative preferred embodiment of the present invention.

FIG. 5 is a side view of the toy-collecting tool of FIG. 4.

FIG. 6 is front side perspective view of a toy-collecting tool in accordance with another alternative preferred embodiment of the present invention.

FIG. 7 is a side view of a toy-collecting tool in accordance with another alternative preferred embodiment of the present invention.

### DETAILED DESCRIPTION OF THE INVENTION

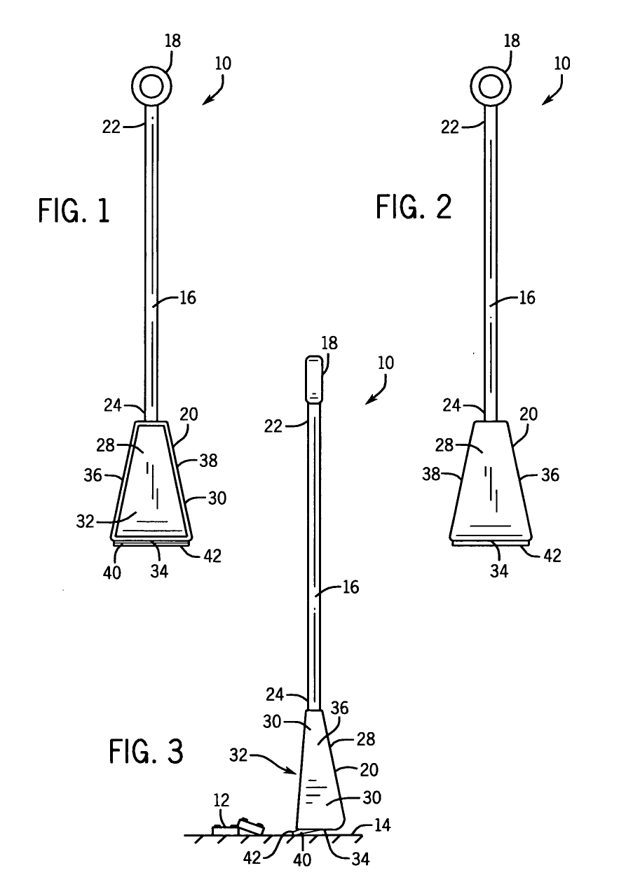

Referring to FIGS. 1 through 3, a preferred embodiment of a tool for collecting toys is generally indicated at 10. The tool 10 is configured to facilitate the collection, retrieval, and general cleaning-up of toys 12 and components thereof from a surface 14 or ground of a play area. The tool includes an elongate shaft 16, a handle 18 and a head 20.

The shaft 16 is an elongate member extending along a longitudinal axis. The shaft 16 is preferably generally cylindrical. The shaft 16 can be a hollow tube, a tube filled with a lightweight material, or a solid generally cylindrical structure. The shaft 16 preferably has a generally circular transverse cross-sectional area. Alternatively, the shaft can have a transverse cross-sectional area of other shapes, such as polygonal, elliptical, irregular or combinations thereof. The transverse cross-sectional area of the shaft 16 is preferably continuous about its longitudinal axis. Alternatively, the transverse cross-sectional area of the shaft can vary along its length. The shaft 16 has a length between the range of 2 to 6 feet, and a diameter between 0.25 to 2.0 inches. More preferably, the shaft has a length in the range of 3 to 5 feet and a diameter between 0.5 inches and 1.5 inches. The shaft 16 is formed of a lightweight material, preferably a plastic or wood. Alternatively, the shaft can be formed of other materials such as, for example, aluminum, fiber composite material, other polymeric materials and combinations thereof.

The handle 18 is coupled to a proximal end 22 of the shaft 16. In one preferred embodiment, the handle 18 is secured to the shaft 16 through the use of one or more fasteners. In alternative preferred embodiments, the handle 18 can be coupled to the proximal end 22 of the shaft 16 in other manners, such as, for example, a threaded connection, snap-fit connection, one or more adhesives, through an intermediate connector or other conventional fasteners. The handle 18 is configured to be readily grasped by a user's hand. In one particularly preferred embodiment, as shown in FIGS. 1 through 3, the handle 18 can have generally circular shape to facilitate grasping and to eliminate an abrupt or sharp end to the toy collection tool 10. The handle 18 of FIGS. 1 through 3 can also be integrally formed or molded with the shaft 16 as a single piece structure. In an alternative embodiment, as shown in FIG. 6, the handle 18 can be cylindrical in shape and extend over the proximal end 22 of the shaft 16. The handle 18 can be formed of a lightweight rigid material, such as a plastic, or a soft resilient material, such a elastomeric or foam layer. A grip 26 can also be applied over the shaft 16 to provide an additional comfortable grippable location for the user's other hand during use. The grip 26 is preferably formed of a grippable, resilient material, such as a rubber. Alternatively, other materials can be used such as, for example, a foam layer, other elastomeric materials, and combinations thereof. In yet another alternative preferred embodiment, the tool 10 can be formed without a handle 18 wherein the proximal end of the shaft 16 serves as the handle.

Referring to FIGS. 1 through 3, the head 20 is coupled to the distal end 24 of the shaft 16. In one preferred embodiment, the head 20 can be coupled to the distal end 24 of the shaft 16 through the use of one or more fasteners. In alternative preferred embodiments, the head 20 can be coupled to the distal end 24 of the shaft 16 in other manners, such as, for example, a threaded connection, snap-fit connection, one or more adhesives, through an intermediate connector or other conventional fasteners. The head 20 is generally V-shaped and includes a rear wall 28 and a continuous side wall 30 forwardly extending from the rear wall 28. The rear and side walls 28 and 30 define a toy collection cavity 32. The toy collection cavity 32 is shaped to facilitate to the gathering, collection and scooping of toys and toy components. The head 20 is formed of a lightweight, rigid material such as a hard plastic. Alternatively, the head 20 can be formed of other materials, such as, for example, aluminum, wood, a fiber composite material, other polymeric material or combinations thereof.

The side wall 30 has a lower region 34 and first and second side regions 36 and 38. The lower region 34 of the side wall 30 has a forward edge 40 extending between of the first and second side regions 36 and 38. As shown in FIG. 3 and FIG. 5, at least a portion of the lower region 34 of the side wall 30 extends substantially parallel with the surface 14 of the play area when the shaft 16 is positioned in a substantially vertical position, and at least a portion of the outer surface of the lower region 34 contacts the surface 14.

A chamfered strip 42 is preferably coupled to the forward edge 40 of the lower region 34. The strip 42 is a resilient tapered edging to facilitate the collection of toys and toy pieces. The strip 42 is configured to drag along the surface 14 and collect and gather toy pieces. The strip 42 is made of a soft, resilient material to prevent scratching or other damage to flooring. The strip is preferably formed of an elastomeric material. Alternatively, other materials can also be used. The strip 42 is preferably formed of a material that is softer than the material used to form the head 20. The head 20 shape and strip 42 facilitate reaching and collecting toys in difficult to retrieve locations, such as corners or beneath chairs or other structures.

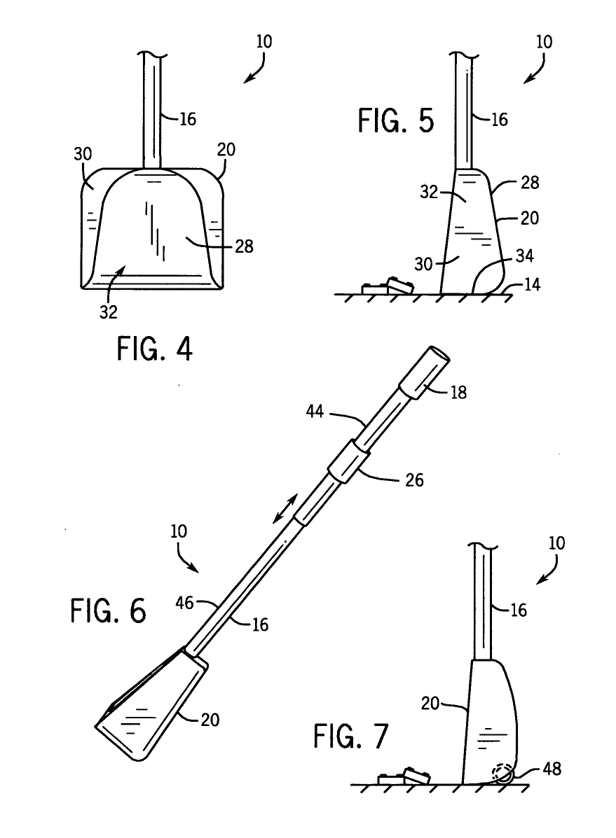

Referring to FIGS. 4 and 5, an alternative embodiment of the present invention is illustrated. The head 20 can be generally U-shaped. The rear wall 28 and the side wall 30 can be configured to form a larger, deeper toy collection cavity 32. The lower region 34 of the side wall 30 can be larger and formed to extend generally parallel with the surface 14 of the play area when the shaft 16 is positioned in a substantially vertical position.

Referring to FIG. 6, another alternative preferred embodiment is illustrated. The shaft 16 can be configured such that its length is adjustable. The shaft 16 can be formed of at least first and second shaft sections 44 and 46 that can be telescopically engaged to allow for the length of the shaft 16 to be selectably adjustable. In other alternative embodiments, the length of the shaft can be adjusted by allowing one section of the shaft to pivot with respect to the other or to be adjustable connected to the each other at different locations along a particular shaft section to allow for different lengths to be achieved.

Referring to FIG. 7, another alternative preferred embodiment of the present invention is illustrated. A pair of wheels 48 can be coupled to the head 20. The wheels 48 are configured to roll along the surface 14 of the play area as the tool 10 is moved with the shaft 16 in a vertical or near vertical position. The wheels 48 can facilitate the sweeping movement of the tool 10 particularly when over deep carpeted surfaces. The wheels 48 can be coupled together through an axle or individually attached to the head 20. Alternatively, the wheels can be replaced with a single elongate roller.

Accordingly, the present invention provides a tool for conveniently collecting toys of various shapes and sizes within a play area. The tool can be used easily and quickly gather and scoop up toys and pieces from the ground of a play area. The tool eliminates the need to repeatedly stoop to gather and pick-up toys and toy pieces from the surface of a play area. The tool is lightweight and configured for easy and safe use by users of all ages including children. In fact, the tool itself can be used by children as a toy. The tool allows children to role play. The tool can be used to help make cleaning up after playtime fun and enjoyable for children. Further, the tool is configured for use on all play surfaces including carpets, rugs, hardwood floors, linoleum, and tiled floors.

While the preferred embodiments of the invention have been illustrated and described, it will be appreciated that various changes can be made therein without departing from the spirit and scope of the invention. Accordingly, it will be intended to include all such alternatives, modifications and variations set forth within the spirit and scope of the appended claims.

What is claimed is:

1. A tool for collecting toys from a play area, the tool comprising:
an elongate shaft having a distal end and a proximal end;
a head coupled to the distal end of the shaft, the head having a rear wall and a continuous side wall forwardly extending from the rear wall, the rear wall and the side wall defining a toy collection cavity, the side wall having a lower region and first and second side regions, the lower region having a forward edge extending between the first and second side regions, the head formed of a first material that is lightweight and rigid; and
a chamfered strip attached to the forward edge of the lower region, the chamfered strip being formed of a second material that is resilient and elastomeric, the strip configured for contacting the toys within the play area without scratching the floor or the walls of the play area.

2. The tool of claim 1, further comprising a handle coupled to the proximal end of the shaft.

3. The tool of claim 2, wherein the handle forms a closed loop for grasping by a user.

4. The tool of claim 1, wherein the shaft is adjustable in length.

5. The tool of claim 4, wherein the length of the shaft is adjustable telescopically.

6. The tool of claim 1, wherein the first material is selected from the group consisting of a hard plastic, wood, a polymeric material and combinations thereof.

7. The tool of claim 1, wherein the second material is selected from the group consisting of rubber, a soft plastic, an elastomer and combinations thereof.

8. The tool of claim 1, further comprising a pair of wheel coupled to the lower region of the side wall to facilitate moving the tool across the ground of the play area when the tool is in a generally vertical position.

9. The tool of claim 1, wherein the first material has a hardness that is greater than the hardness of the second material.

10. The tool of claim 1 wherein the head is generally U-shaped.

11. The tool of claim 1, wherein the head is generally V-shaped.

12. The tool of claim 1, wherein the head configured such that when the shaft is positioned in a substantially vertical position, at least a portion of the lower region of the side wall extends substantially parallel with the ground of the play area and at least a portion of an outer surface of the lower region contacts the ground of the play area.

13. A tool for collecting toys from a play area, the tool comprising:
an elongate shaft having a distal end and a proximal end; and
a head coupled to the distal end of the shaft, the head having a curved rear wall and a continuous side wall forwardly extending from the rear wall, the rear wall and the side wall defining a toy collection cavity, the side wall having a lower region and first and second side regions, the lower region having an outer surface and a forward edge extending between the first and second side regions, the head configured such that when the shaft is positioned in a substantially vertical position, at least a portion of the lower region of the side wall extends substantially parallel with the ground of the play area and at least a portion of the outer surface of the lower region contacts the ground of the play area, the head configured for contacting, collecting and scooping of the toys within the play area.

14. The tool of claim 13, further comprising a handle coupled to the proximal end of the shaft.

15. The tool of claim 14, wherein the handle forms a closed loop for grasping by a user.

16. The tool of claim 13, further comprising a pair of wheel coupled to the lower region of the side wall to facilitate moving the tool across the ground of the play area when the tool is in a generally vertical position.

17. The tool of claim 13, further comprising a chamfered strip attached to the forward edge of the lower region, the chamfered strip being formed of a resilient and elastomeric material, and wherein the strip is configured for contacting the toys within the play area without scratching the floor or the walls of the play area.

18. The tool of claim 13, wherein the head is one of generally U-shaped and generally V-shaped.
